(19) United States
(12) Patent Application Publication
(10) Pub. No.: US 2014/0379099 A1
(43) Pub. Date: Dec. 25, 2014

(54) CONTROL SYSTEM AND METHOD FOR CONTROL OF ELECTRICAL DEVICES

(71) Applicant: SONY CORPORATION, Minato-ku, Tokyo (JP)

(72) Inventors: Geert Premereur, Erpe-Mere (BE); Bert Robben, Bierbeek (BE); Michel Tilman, Ninove (BE); Chris Minnoy, Holsbeek (BE); Alfred Spiessens, Hingene (BE)

(73) Assignee: SONY CORPORATION, Minato-ku, Tokyo (JP)

(21) Appl. No.: 14/370,652

(22) PCT Filed: Jan. 11, 2013
(86) PCT No.: PCT/EP2013/050505

§ 371 Date: Jul. 3, 2014

(30) Foreign Application Priority Data
Jan. 13, 2012 (EP) 12151073.9

(51) Int. Cl. G05B 15/02; H02J 3/14

(52) U.S. Cl. CPC G05B 15/02; H02J 3/14
USPC 700/19

(57) ABSTRACT

A control device and a corresponding control method for controlling one or more electrical devices, each having a device profile including energy usage-related information of the device. The control device includes a profile input that obtains device profiles of electrical devices to be controlled from a device-specific storage location identified by a device-specific location identifier, an identifier input that receives device-specific location identifiers and/or device identifiers usable for generating respective device-specific location identifiers, a control unit that processes obtained device profiles and generates control commands for controlling the one or more electrical devices based on the obtained device profile, and a control output that provides the control commands.

### FIELD OF THE INVENTION

The present invention relates to a control device and a corresponding control method for controlling one or more electrical devices, each having a device profile including energy usage-related information of the device. The present invention relates further to an electrical device having a device profile including energy usage-related information of the device. The present invention relates further to a control system and a corresponding control method that can be performed in such a control system.

### BACKGROUND OF THE INVENTION

Until now, demand-response has been mostly provided by out-of-band communication. For example, a utility company, often through intermediaries, notifies a large number of smaller customers that they should manually turn off electrical devices that are agreed upon ahead of the demand-response event. A step up is where such devices are attached to a communication network and are triggered by messages sent over said communication network. It is possible to use the electricity network itself as the communication network. The known approaches are mostly useful for reducing peaks on the electrical power distribution network.

Another approach is where devices negotiate with a party whether and how much electrical energy they should consume or make available. Taking into account only past and current measurements can be used to reduce both consumption beyond and below previously anticipated levels. The most advanced systems integrate predictions of external factors such as temperature, wind speed and cloud coverage together with general and averaged estimates of power consumption and generation. Besides reducing deviations against provisioned power levels, the more advanced systems can also be employed to target other goals and/or a different target audiences, for example minimising the amount a large energy consumer has to pay for the energy it buys from a provider.

US 2011/0060476A1 discloses an energy management system that includes an energy supply device and an energy demand device. The energy management system comprises a first device, a second device, storage sections and calculating sections. The first device is applied for the energy supply device. The second device is applied for the energy demand device. The storage sections are included in the first device and the second device, respectively, and store a condition as to comply with an adjustment request of energy supplied from the energy supply device to the energy demand device. The calculating sections are included in the first device and the second device, respectively, and cooperate to execute negotiation function calculating an energy adjustment amount satisfying the condition.

### BRIEF SUMMARY OF THE INVENTION

It is an object of the present invention to provide an improved control device and a corresponding control method for controlling one or more electrical devices as reliably and accurately as possible. It is a further object of the present invention to provide a corresponding control system and method.

According to an aspect of the present invention there is provided a control device comprising:
a profile input that obtains device profiles of electrical devices to be controlled from a device-specific storage location identified by a device-specific location identifier,
an identifier input that receives device-specific location identifiers and/or device identifiers usable for generating respective device-specific location identifiers,
a control unit that processes obtained device profiles and generates control commands for controlling said one or more electrical devices based on the obtained device profiles, and
a control output that provides said control commands.

According to a further aspect of the present invention there is provided an electrical device having a device profile including energy usage-related information of the device, the device comprising:

an identifier output that outputs a device-specific location identifier and/or a device identifier that can be used to generate a device-specific location identifier, said device-specific location identifier identifying a device-specific storage location of the device profile of said device,
a control input that receives control commands for controlling said device based on the device-specific device profile, and
a processor for executing said control commands.

According to still a further aspect of the present invention there is provided a control system comprising:
a control device according to the present invention,
one or more electrical devices according to the present invention controlled by said control device,
one or more storage units that store device profiles of said one or more electrical devices, said one or more storage units being identified by said device-specific location identifiers,
a first connection that connects the identifier output of said one or more electrical devices and the identifier input of said control device,
a second connection that connects the control output of said control device and the control input of said one or more electrical devices and
a third connection that connects the profile input of said control device and said one or more storage units.

According to further aspects corresponding control methods are provided according to the present invention.

According to still further aspects a computer program comprising program means for causing a computer to carry out the steps of the method according to the present invention, when said computer program is carried out on a computer, as well as a computer readable non-transitory medium having instructions stored thereon which, when carried out on a computer, cause the computer to perform the steps of the method according to the present invention are provided.

Preferred embodiments of the invention are defined in the dependent claims. It shall be understood that the claimed control methods have similar and/or identical preferred embodiments as the claimed control device and system and as defined in the dependent claims.

The invention is applied in a demand response environment where one or more (energy consuming and/or producing) electrical devices from one or more different vendors and/or brands are controlled by means of a controlling party (i.e. the control device) external to the electrical devices. The controlling party may use some prediction of the future to optimize e.g. the timing of power and/or energy allocations to be sent to the electrical devices taking part in a demand-response scheme. In such an environment, the controlling party (i.e. the control device) preferably has access to up-to-date device profiles to perform in an optimal fashion. This is ensured according to the present invention by making an information (i.e. a device-specific location identifier) available to the controlling party signaling where (i.e. from which device-specific storage location) the actual and up-to-date device profile of an electrical device to be controlled can be retrieved.

Generally, in the same way, by the same control device and/or by use of the same device profile one or more electrical devices can be controlled.

Particularly the device operation and/or the energy consumption and/or production of the electrical devices may be controlled, e.g. optimized in view of demand response considerations. For the control separate control models may be used, e.g. a different model for each different kind of demand response goal to be achieved. Such demand response goals might e.g. be minimizing local energy cost or avoiding blackouts. The device profiles and the control may also take into account the surroundings of the device, the climate of the surroundings, the manufacturer, and other factors related to the device.

The device-specific storage location is generally a storage location (e.g. a location or place in a storage, memory, server or web resource) which is accessible by the control device. It may be identical for two or more electrical devices, in particular for electrical devices of the same type or brand, but may also be individual for each single electrical device. The storage location can even be in the electrical device itself. Preferred locations are storage locations provided by the manufacturer or vendors of the electrical devices, e.g. on a server managed by the manufacturer or vendor, central databases that are specifically provided for storing device profiles of various devices, e.g. of all kinds of washing machines, or storage locations provided by the user or owner of multiple electrical devices (e.g. a database in a factory).

Preferably, the device-specific storage locations can be accessed also by the manufacturer and/or distributor of the electrical devices to have ability to change the device profiles, for instance in case of any update of the operating system or any operational parameters of the associated device. In one embodiment, the device-specific storage location is also accessible by, a control device e.g. provided in a home network and/or the electrical device itself. For example, the control device or electrical device (or in one embodiment even the associated external control device) may then further update the device profile based on information collected during the lifetime of the device or based on information about the specific surroundings of the device.

In a preferred embodiment of the invention, an aspect of using device-specific storage locations for profiles is that profiles can be adapted after the electrical devices to which said profiles pertain have been commercially deployed. This allows manufacturers and independent optimization service providers to fine-tune profiles as more information about real-life use of electrical devices becomes available.

Similarly, the device-specific location identifier may be identical for two or more devices, in particular for devices of the same type or brand, but may also be individual for each single device. Preferably, URIs (Uniform Resource Identifiers) can be used as device-specific location identifiers. In an embodiment URLs (Uniform Resource Locators) that point to a certain storage location in the Internet or that point back to the device itself can be used. In another embodiment URNs (Uniform Resource Names) can be used. Generally, URI, URL and URN shall be understood as described in IETF RFC 3986 (currently e.g. available at http://tools.ietf.org/html/rfc3986).

For some devices the device-specific location identifiers can be updated as part of a regular device firmware update. It is also envisioned that end-users or service technicians might change device-specific location identifiers. However, the value of using URIs lies in the possibilities for indirection that is inherent with URIs. If a device employs URNs, a mapping to URLs is in some embodiments mandatory to resolve a device-specific location identifier. This mapping can be influenced in the control device or supporting optimization services. If URLs are used, a mapping to a different URL is still possible. Furthermore, judicious use of DNS (RFC 1034) technology allows yet another way of resolving desired device-specific storage locations. For instance, URL host names of the form “deviceX.kindY.local.” may be used in an embodiment which enables the control device to use a specific DNS configuration to direct which profile servers are resolved.

Devices may publish more than one URI, for example one URN that should be mapped by a control device to a device-specific location as best suits its needs, one URL that refers to a device manufacturer's own device profile server and one URL that refers to a profile server embedded in the device itself. The control device may then try to resolve a device-specific location by successively trying to interpret the URIs until it can successfully fetch a profile.

In this context a device profile shall be understood as a collection of device-related information, particularly including energy usage-related information of an electrical device. In particular, energy usage-related information may be information which characterizes the (e.g. past and/or current and/or expected) energy consumption and/or the energy production of an electrical device, e.g. the power consumption and/or production over time. In addition, the device profile may indicate flexibilities as regards the time and/or amount of energy or power consumption and/or production. Furthermore, the device profile could include e.g. technical or user-specific constraints.

The device profile may thus, generally, include one or more of an attribute value concerning the adjustable energy amount, for example information of an adjustable amount of an energy consumption (utilization) of the load, information of a shiftable amount in a time direction in a case where a time to generate the energy consumption of the load can be shifted, information of an operation time of the load (the utilization time of the energy) and/or an adjustment amount of an accumulated energy of the load, information of a propriety (possibility) of blocking of the energy consumption of the load (forced load blocking), information of the consumption of the load or an amount of energy to be generated, and/or an error amount or an error ratio thereof (a specific value of a variance range of the energy consumption of a load whose demand cannot be predicted such as a non-networking load or a variance range of the amount of the power to be generated by a distributed power source whose amount of the power to be generated cannot be predicted such as the solar power generation or the like). The device characteristics that let an optimizer come up with an optimized solution are included in a device profile. The device profiles may also take into account the characteristic energy consumption (or variations thereof) of the devices, variations in the manufacturing/operation of the devices, other constraints of the device, the control, the technical infrastructure, or the user.

It is important to note that a typical device profile is not a fixed set of power production/consumption over time but a recipe for the way an electrical device behaves given certain control inputs. The more flexibility, i.e. the greater and the more fine-grained variations, the device profile allows, the more valuable the device profile is. A device profile can be expressed in multiple ways. For example by functions in the mathematical sense that describe the device's capabilities in full detail or by enumeration of several sets of possible energy states discretized over time. Profiles can include a preference for one or more or all of the various operating schedules they describe.

For instance, in the case of a washing machine, the device profile of the washing machine may include, per program and sub-program, the sequence of sub-programs, the duration, the energy usage requirements and, to indicate flexibilities, the minimum and maximum allowed times until the next sub-program is run. Another example concerns charging batteries. A device profile for a battery could indicate flexibilities, since batteries may be charged normally, but they may also be charged using fast charging. Further, while batteries may be charged in one go or in several sessions, constraints on the minimal uninterrupted charging time in any charging session may be imposed. Still another example is the device profile of an electric car to be charged at home overnight. The device profile, for instance, depends on the battery characteristics and state. A typical car battery with 50% charge level may take up to 4 hours of normal charging. The proposed control device is allowed to plan the charging session whenever it wants (e.g. in 16 blocks of 15 minutes each with pauses in between instead of a single, continuous block of 4 hours; the single block option might have a higher preference however as it causes less wear on the components of the washing machine). Constraints in the device profile may impose limits for start and end time or, as a technical constraint, a minimum energy amount needed to enable proper charging. In some cases, additional constraints are provided external to the device profile (e.g. the maximum amount of power that can be sustained by the electrical wiring supplying power to the electrical device).

Thus, generally a device profile captures the expected energy consumption and production characteristics of a device, and may include intrinsic, device-related constraints. Device profiles preferably assume a closed-world view, whereby each device is independent from other devices, but properly configured for their environments. Thus, default profiles may be used as well, at least initially, which may then be further improved. A simple default profile may be a block of constant power production/consumption with a value for the average power production/consumption during some time period. In other embodiments, device profiles reflect the surroundings of the corresponding devices, e.g. other devices connected in their neighborhood, in the same home network or similar. In this case, the profiles still describe the behavior and flexibility of a single device, but they take into account how said behavior and flexibility are influenced by the environment in which the device operates. For example, the same type of washing machine during the winter in a Nordic country will be supplied with colder water and thus require more electric energy to heat water than one in an equatorial country. In addition, the device profile may include different kinds of operating parameters of the device.

The operation of the control unit, which may be part of the control device or at least connected to the control device, i.e. how the control commands are generated from a device profile of an electrical device, is generally known in the art and is, for instance, described in ISO/IEC 14543-3 (KNX) or ISO/IEC DIS 14908 (LON).

In this context it shall be noted that the expressions “control device” and “control unit” shall not be understood in the sense that an electrical device is completely or directly “controlled” by the control device as proposed according to the present invention. While this is possible according to one embodiment, the control may also take place indirectly. For example, an electrical device has its own built-in control device for general operation and control of the electrical device. In this case, the proposed control device may provide the control commands to the built-in control device that will then govern the way in which it operates and controls the electrical device based on these control commands.

The control commands may e.g. comprise power prosumption (prosumption=production and/or consumption) functions for the electrical devices that are used to optimize the quantity and scheduling of the energy prosumption of the devices. They may be represented as discrete lists of power values (e.g. expected power consumption for every 5 minutes), or as actual mappings from the time domain to power values, in a form suited to the algorithms (e.g. linear programming) used by the control device. In other embodiments the control commands may be on a higher level, e.g. start/stop/pause/resume, start a certain program x, operate at certain rotations per minute, charge at a certain voltage/current z, etc.

### BRIEF DESCRIPTION OF THE DRAWINGS

These and other aspects of the present invention will be apparent from and explained in more detail below with reference to the embodiments described hereinafter. In the following drawings

FIG. 1 shows a schematic diagram of a conventional control system,

FIG. 2 shows a schematic diagram of a first embodiment of a control system according to the present invention,

FIG. 3 shows a schematic diagram of an embodiment of an electrical device according to the present invention,

FIG. 4 shows a schematic diagram of a second embodiment of a control system according to the present invention,

FIG. 5 shows a schematic diagram of a third embodiment of a control system according to the present invention,

FIG. 6 shows a schematic diagram of a fourth embodiment of a control system according to the present invention,

FIG. 7 shows a schematic diagram of a fifth embodiment of a control system according to the present invention,

FIG. 8 shows a schematic diagram of a sixth embodiment of a control system according to the present invention,

FIG. 9 shows two flow charts illustrating the control methods according to the present invention, and

FIG. 10 shows a schematic diagram of a seventh embodiment of a control system according to the present invention.

### DETAILED DESCRIPTION OF THE INVENTION

The present invention is applied in a demand response environment where electrical devices are controlled by means of a party external to the device. One example of such an environment is a home energy network that combines electrical appliances, measurement devices and a control device, e.g. implemented as a software program on a controller, processor or computer or implemented as dedicated hardware such as an integrated circuit, which can control the electrical devices, in particular influence when appliances are turned on and off, if and when energy usage-related information, e.g. operating parameters, are changed, etc. More specifically, the present invention preferably operates in a setting where the controlling party (i.e. the control device) uses some (expected) knowledge of the future to optimize the timing of the power allocations sent to the electrical devices taking part in the demand-response scheme. The more accurate and precise the information is the controlling party has about the future, the better it can optimize how the devices are controlled and used. For example, such information (or, to be more precise, prediction) of the future may generally specify the effects of sending control commands to electrical devices, which is covered by the device profiles.

It is quite typical for many electrical devices that the energy they consume once they enter a certain state is quite predictable, since it is tied to the physical process they implement. Also, the same device can exhibit different usage patterns depending on the mode of use. For instance, considering as an example a modern washing machine, it has many different programs, each of which consists of sub-programs that use different amounts of energy for different lengths of time. Generally, there is no time between these sub-programs for most washing machines since they try to minimize the total duration. However, in a monetary or network optimization strategy it can be useful to also let the time gap between sub-programs vary.

As mentioned above, all the device characteristics that let an optimizer (i.e. control device) come up with an optimized solution (e.g. an energy consumption and production schedule optimized in view of demand response considerations) can be grouped in a device profile. In the case of the washing machine example this is, per program and sub-program, the sequence of sub-programs, the duration, the energy usage requirements and the minimum and maximum allowed times until the next sub-program. The device characteristics may partly vary for different types of electrical machines, e.g. washing machines, dish washers, TV sets, cooking appliances, refrigerators as used in private households or all kinds of professional machines like robots, electrical motors in factories.

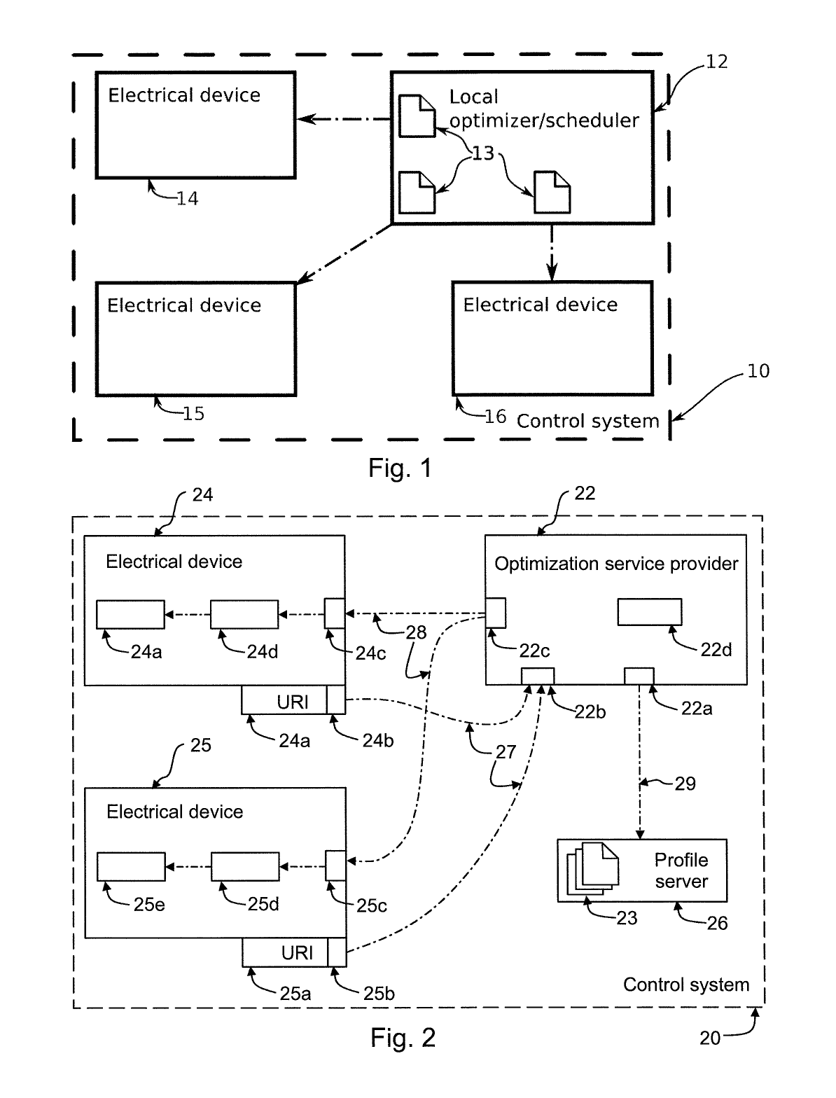

FIG. 1 shows a schematic diagram of a control system 10 in general. It comprises a control device 12 (called “local optimizer/scheduler” in this embodiment; also generally called “optimizer” in the following) and several electrical devices 14, 15, 16 to be controlled. The control device 12 stores a device profile 13 for each electrical device 14, 15, 16 including energy usage-related information of the respective device.

For scheduling and/or controlling the energy consumption and/or production, the control device 12 uses device profiles as described above. In practice, it is often the case that device profiles are updated from time to time. For instance, some time after introduction of a new device on the market and after getting some practical experience one or more energy usage-related information, such as certain operating parameters, may be optimized and/or errors may be removed. For this purpose, the respective device profile may be updated, e.g. by a service technician or via telemaintenance by the manufacturer or a service company. In this case the stored device profiles 13 are no longer the most recent and current device profiles. The present invention addresses this problem and proposes a solution so thatan optimizer can access device profiles.

Managing device profiles in the optimizer itself is not feasible because the introduction of a new electrical device would also require upgrading the optimizer. Putting the device profiles in the electrical devices itself alleviates this problem, but precludes using evolved device profiles that only become available after an electrical device is installed. This is a real possibility, as explained above, as these device profiles can take into account environmental influences that are difficult to exhaustively reproduce in an often short pre-commercialization phase.

Therefore, a more advanced control system is proposed according to the present invention. A schematic diagram of a first embodiment of a control system 20 according to the present invention is shown in FIG. 2. The control system 20 comprises a control device 22 (here called “optimization service provider”), one or more electrical devices, here two electrical devices 24, 25, controlled by said control device 22, and one or more storage units 26, here a single profile server 26, that store device profiles 23 of said electrical devices 24, 25. In this control system 20 the storage unit 26 (or more storage units, if available) is identified by a device-specific location identifier, i.e. for each device a location identifier is available to the control device 22 that identifies the storage location where the device profile of the device is stored. In the embodiment shown in FIG. 2 there is only a single storage unit 26 so that the device-specific location identifiers 24a, 25a are all at least identical in their host name part and point to the storage unit 26, preferably together with a sub-pointer that directly points to the right device profile 23 for the corresponding device 24, 25.

For connecting the various elements of the control system 20 it further comprises a first connection 27 that connects identifier outputs 24b, 25b of said electrical devices 24, 25 and an identifier input 22b of said control device 22. A second connection 28 is provided that connects a control output 22c of said control device 22 and control inputs 24c, 25c of said electrical devices 24, 25. Further, a third connection 29 is provided that connects the profile input 22a of said control device 22 and said storage unit 26. The first to third connections may enable wired or wireless communication between the respective components. Preferably, the latency on the connections should not be too high.

Preferably, the optimizer, i.e. the control device 20, should have a low-latency connection to the electrical devices and should have as much knowledge as possible about a device in order to effectively manage it. However, to make the optimizer as universally applicable as possible, it should only rely on standardized data and not require device-specific rules. That data is captured in a device profile. A plurality of devices is preferably controlled by a local optimizer, e.g. in the same room, house, building, factory, city, etc. using individual device profiles. In general, however, the location of the optimizer is not relevant. The location of any sensors, e.g. for sensing any parameters or conditions (see below) is generally more relevant. For example, measuring voltage at the home entrance will have less accuracy in determining the patterns of a dishwasher than when measuring the voltage at the plug of the dishwasher.

Generally, a device profile is used to optimize electricity production/consumption. The device profile may describe the constraints and cause/effect relationships between receiving a command and the resulting power draw/generation. Generally, it does not specify when a certain command should be sent. That is the role of the optimizer that considers e.g. a number of devices, their individual profiles, the target consumption/generation and optimization algorithm parameters. In an example a washing machine profile shall be considered, said washing machine profile specifying that a certain program starts by using 500 W for 3 minutes followed by 2000 W for 12 minutes. There are two identical washing machines available to control. An optimizer having a target that 350 Wh should be consumed in the first quarter of an hour will start the first washing machine immediately (500 W*3/60 h+1200 W*10/60 h=225 Wh), while the second washing machine is started after 7 minutes (500 W*3/60 h+1200 W*5/60 h=125 Wh) for a total of 350 Wh. This scenario shall be compared with an optimizer that has no profile information, but can only measure the effect of starting a washing machine. It starts a washing machine immediately (again 225 Wh in 15 minutes) and another washing machine immediately after measuring the effect of starting the first washing machine (just a bit less than 225 Wh in 15 minutes). It does so because, having no view of the future through the profile, it expects that the first washing machine will keep on using 500 W for the next 15 minutes. The result is a usage of 450 Wh instead of the intended 350 Wh. Algorithms for finding such an optimal solution are widely known and can be based on “constraint programming” as e.g. described in Paul Shaw “Using Constraint Programming and Local Search Methods to Solve Vehicle Routing Problem”, CP '98 Proceedings of the 4th International Conference on Principles and Practice of Constraint Programming, Springer Verlag, 1998. If many devices are involved approximations to the optimal solutions have to be searched. One technique is solving a multi-dimensional bin packing problem e.g. as described in Chandra Chekuri and Sanjeev Khanna “On Multi-dimensional Packing Problems”, SIAM Journal on Computing, Volume 33, Issue 4, 2004, pages 837-851.

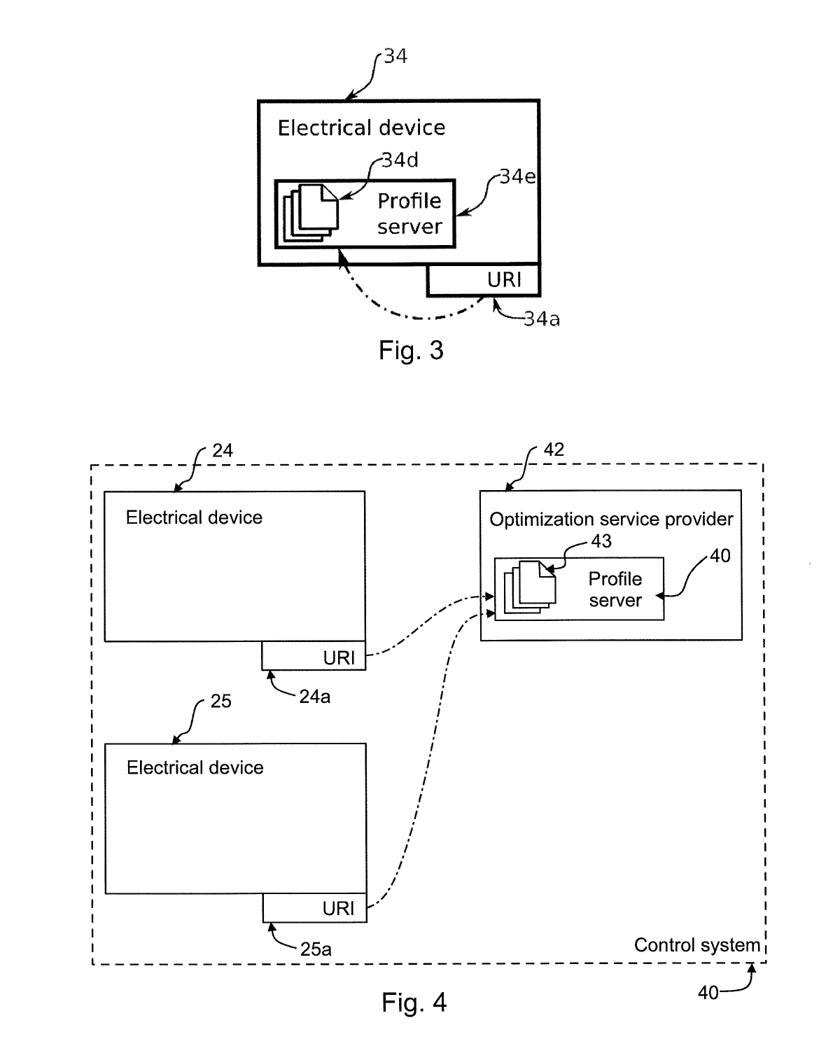

According to a preferred embodiment the electrical devices 24, 25 make available one or more URIs as location identifiers to the controlling party, i.e. the control device 22, signaling where their respective device profiles can be retrieved. These URIs can be Internet URLs, as preferably shown in FIG. 2, or point back to the device itself, as shown in FIG. 3 depicting a block diagram of an embodiment of an electrical device 34 that hosts its own device profile 34d, e.g. on an embedded server such as an embedded web server or any other kind of internal storage 34e that can be accessed by the control device by use of the URI 34a. Internet URLs allow for after-release updates of device profiles while device-local URIs can provide a fallback strategy in case the Internet URL cannot be connected to.

Internet URLs preferably point to a central vendor-neutral or a vendor-specific repository (storage location). The URL scheme can be of the form https://<repo host name>/profiles/<vendor>/<brand>/<appliance type>/<type id>.

Local URIs can be of the form http://<device host name>/profile for devices that sport an HTTP-server. For simpler devices the profile can be specified in the URI itself such as urn://profile/<device id>?profile_spec=<ps>. The <ps>part is then a base64-encoded version of the same device profile data format as used in an external profile repository. Further, URNs can be used e.g. of the form urn:dr:dev:wm:98723497823. This URN is used by a profile mapper within the control device to look in a local or remote mapping database to come up with a URL that can be handled as described before.

As shown in FIG. 2 a control device 22 according to the present invention for controlling one or more electrical devices, each having a device profile including at least energy usage-related information of the device, generally comprises a profile input 22a that obtains device profiles of electrical devices to be controlled from a device-specific storage location identified by a device-specific location identifier, an identifier input 22b (which generally should be adapted to the type and/or format of identifier or should be configured to be able to interpret several or all types and/or formats of identifiers) that receives device-specific location identifiers and/or device identifiers that are used, e.g. within the control device or by another entity, to generate respective device-specific location identifiers, a control unit 22d that processes obtained device profiles and generates control commands for controlling said one or more electrical devices based on the obtained one or more device profiles, and a control output 22c that outputs said control commands to the one or more electrical devices to be controlled.

Further, as shown in FIG. 2, an electrical device 24, 25 according to the present invention generally comprises an identifier output 24b, 25b that outputs a device-specific location identifier 25a, 25b and/or a device identifier (not shown in this embodiment) that can be used to generate a device-specific location identifier, said device-specific location identifier identifies a device-specific storage location of the device profile of said device, a control input 24c, 25c that receives control commands for controlling said device, and a processor 24d, 25d for executing said control commands.

Preferably, an additional internal control unit 24e, 25e is provided that performs the actual operation and control of the device 24, 25. Based on the processed control commands the operation and control the respective device 24, 25 by the respective control unit 24e, 25e is modified. In other embodiments, however, a direct control of the device 24, 25 by the control commands may be possible.

As explained above the device-specific storage location is generally a storage location (e.g. a location or place in a storage, memory, server or web resource) which is accessible by the control device. It may be a fixed predetermined storage location, but can also be variable. The party (i.e. the controller) interpreting the identifier (e.g. the URI) can generally transform/map it to another one and have it point to another location. Thus the storage location is not generally predetermined. In fact, in case of a URN, there is even no location. Also, even if an URL is used as is, this can point to different physical locations completely out-of-control of the controller as a URL is only an identifier for another party allowing it to identify a resource. For instance, a web server might use an HTTP URL to make a query in a database to assemble a fitting profile. But it might also directly point to a fixed file, or the web server might only be a proxy for another web server. This is one or the reasons for working with URLs, and more in general URIs. They allow all kinds of manipulation, configuration and/or indirection. In other words, URIs finally lead to a device-specific storage location, but that storage location is not generally predetermined and fixed and there are configurations (embodiments) in which the storage location is determined much more dynamically.

FIG. 4 shows a schematic diagram of a second embodiment of a control system 40 according to the present invention. In this embodiment the storage unit 46 is part of the control device 42. The location identifiers 24a, 25a then are either URNs that are mapped to URLs pointing to storage locations in the control device or else URLs that may need to be rewritten to point to storage locations in the control device.

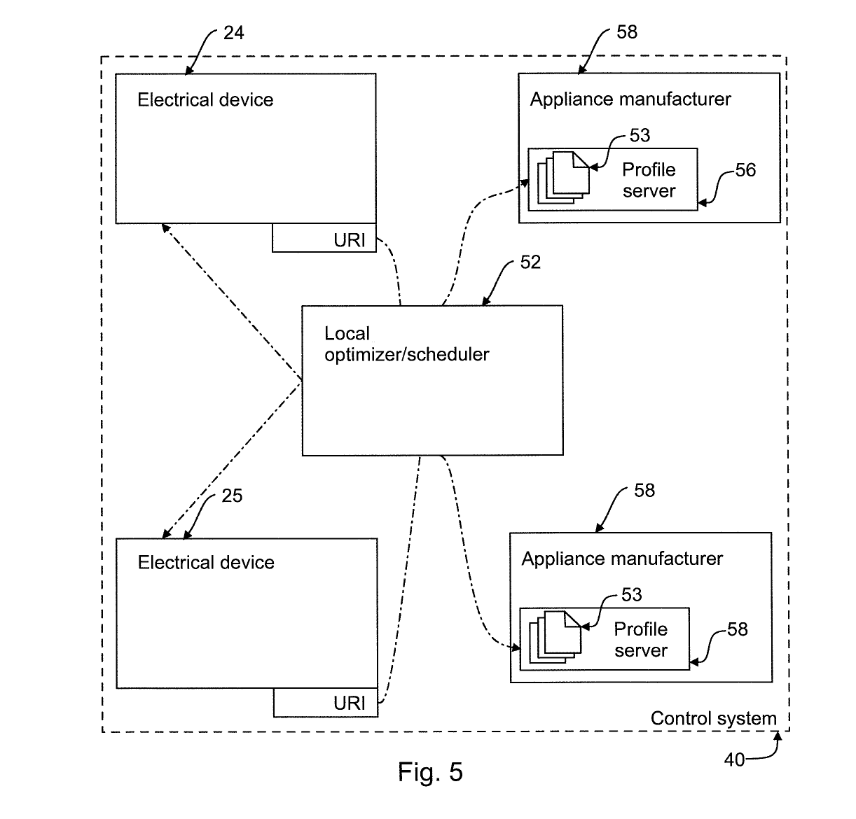

FIG. 5 shows a schematic diagram of a third embodiment of a control system 50 according to the present invention. In this embodiment the device profiles 53 are hosted by an external provider, e.g. the appliance manufacturers 58 of the respective device or a profile server 56 administered by the appliance manufacturers 58. The URIs may be URLs pointing to the provider or URNs that are interpreted by the local optimizer (i.e. the control device) to yield a URL.

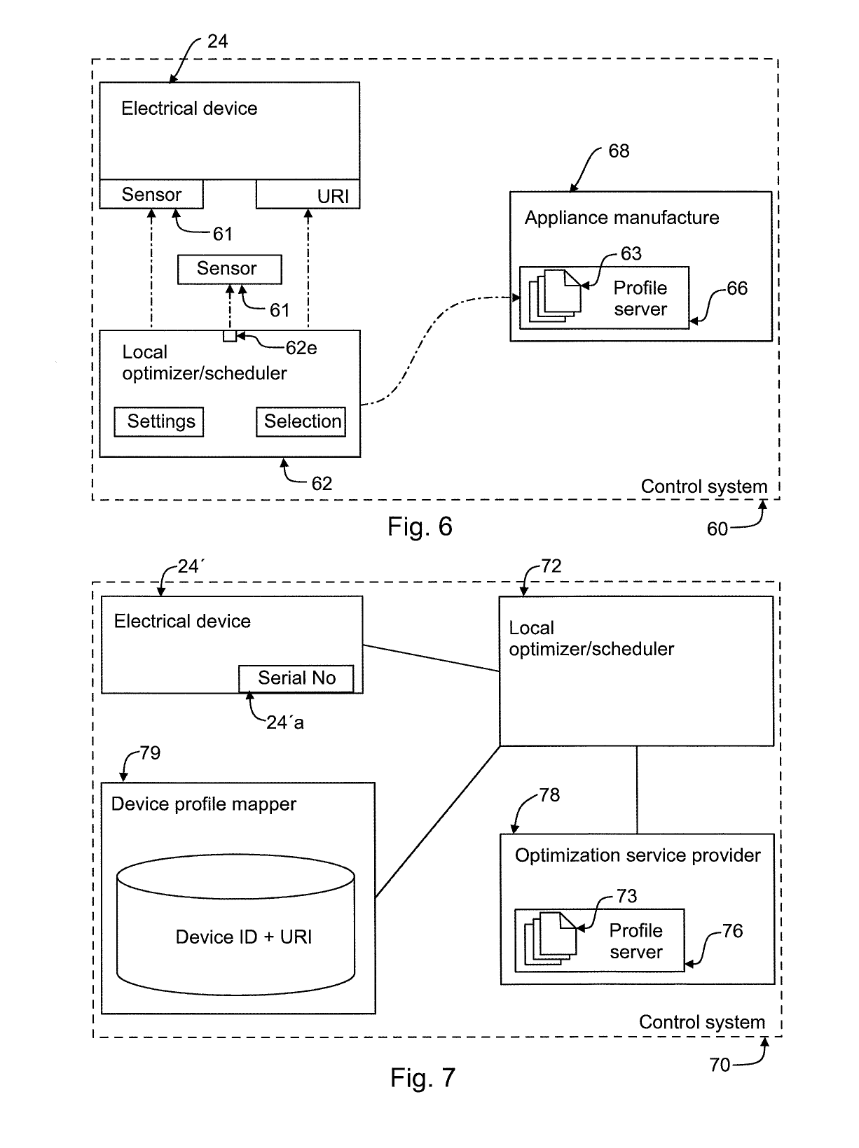

FIG. 6 shows a schematic diagram of a fourth embodiment of a control system 60 according to the present invention. Since device profiles 63 can depend on the environment (e.g. temperature, humidity, . . . ) as sensed by sensors 61 provided in this embodiment (and input to the local optimizer at a sensor input 62e) and the settings of and selections of the local optimizer 62, the local optimizer 62 can use the device URI to construct a URL for an external profile server 66, e.g. stored on an optimization service provider 68 that can yield best matching profiles. The optimization service provider thus provides a service beyond the static lookup in FIGS. 2 and 5. Externally it has the same usage contract (lookup by URL), but internally it looks up a best matching profile from multiple profile candidates.

FIG. 7 shows a schematic diagram of a fifth embodiment of a control system 70 according to the present invention. For “dumb” devices 24′ that do not know that they are being managed by a smart optimization procedure, the local optimizer 72 can capture some kind of fingerprint or device identifier (e.g. electrical usage pattern or a serial number from a different protocol). This fingerprint is then analyzed by an external device profile mapper 79 that holds a database of fingerprints and location identifiers. The device profile mapper 79 then yields a URI, i.e. a location identifier, to the local optimizer 72 in place of the device 24′ itself. Afterwards this URI is used as before, e.g. to look up a device profile 73of the device 24′ by use of an URL in a central profile server 76.

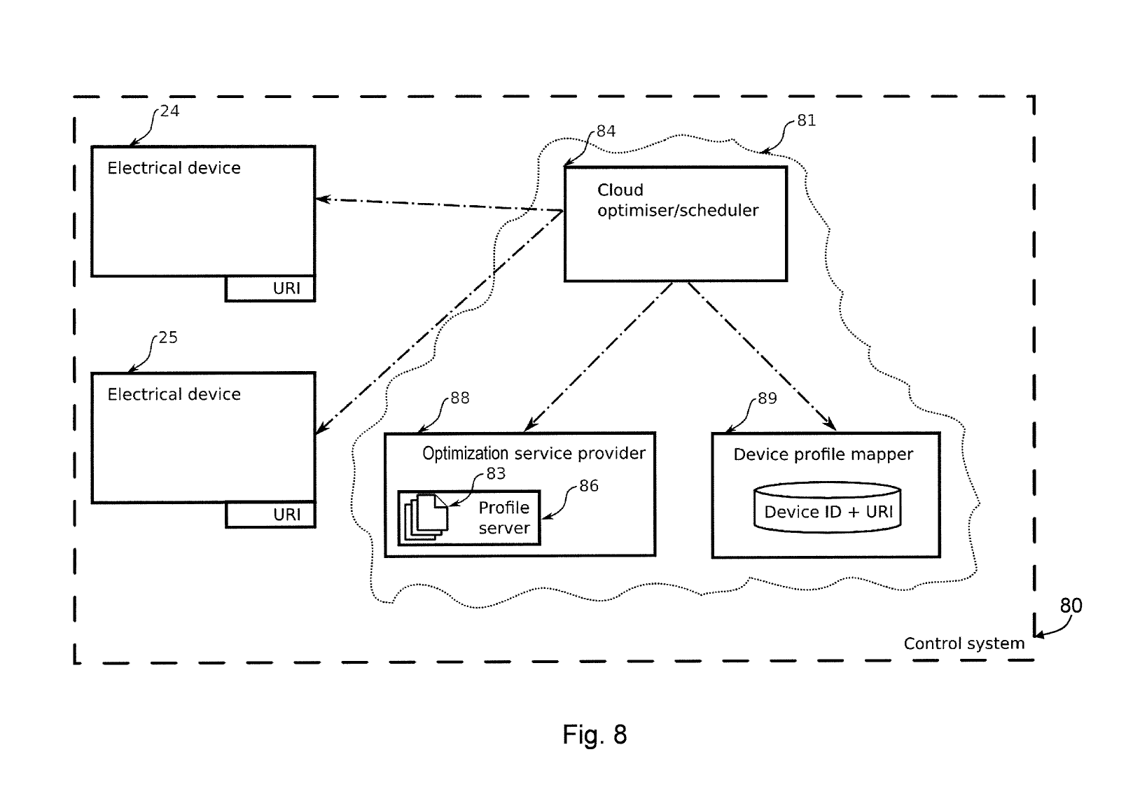

FIG. 8 shows a schematic diagram of a sixth embodiment of a control system 80 according to the present invention. In this embodiment it is shown that the optimizer 84 and the optimization service provider 88 holding the profile server 86 and the device profile mapper 89 may be part of a cloud 81. In other embodiments only one or more of these elements may be part of a cloud.

In general, the concepts of “virtual” and “cloud computing” include the utilization of a set of shared computing resources (e.g. servers) which are typically consolidated in one or more data center locations. For example, cloud computing systems may be implemented as a web service that enables a user to launch and manage computing resources (e.g. virtual server instances) in third party data centers. In a cloud environment, computer resources may be available in different sizes and configurations so that different resource types can be specified to meet specific needs of different users. For example, one user may desire to use small instance as a web server and another larger instance as a database server, or an even larger instance for processor intensive applications. Cloud computing offers this type of outsourced flexibility without having to manage the purchase and operation of additional hardware resources within an organization. A cloud-based computing resource is thought to execute or reside somewhere on the “cloud”, which may be an internal corporate network or the public Internet. From the perspective of an application developer or information technology administrator, cloud computing enables the development and deployment of applications that exhibit scalability (e.g., increase or decrease resource utilization as needed), performance (e.g., execute efficiently and fast), and reliability (e.g., never, or at least rarely, fail), all without any regard for the nature or location of the underlying infrastructure.

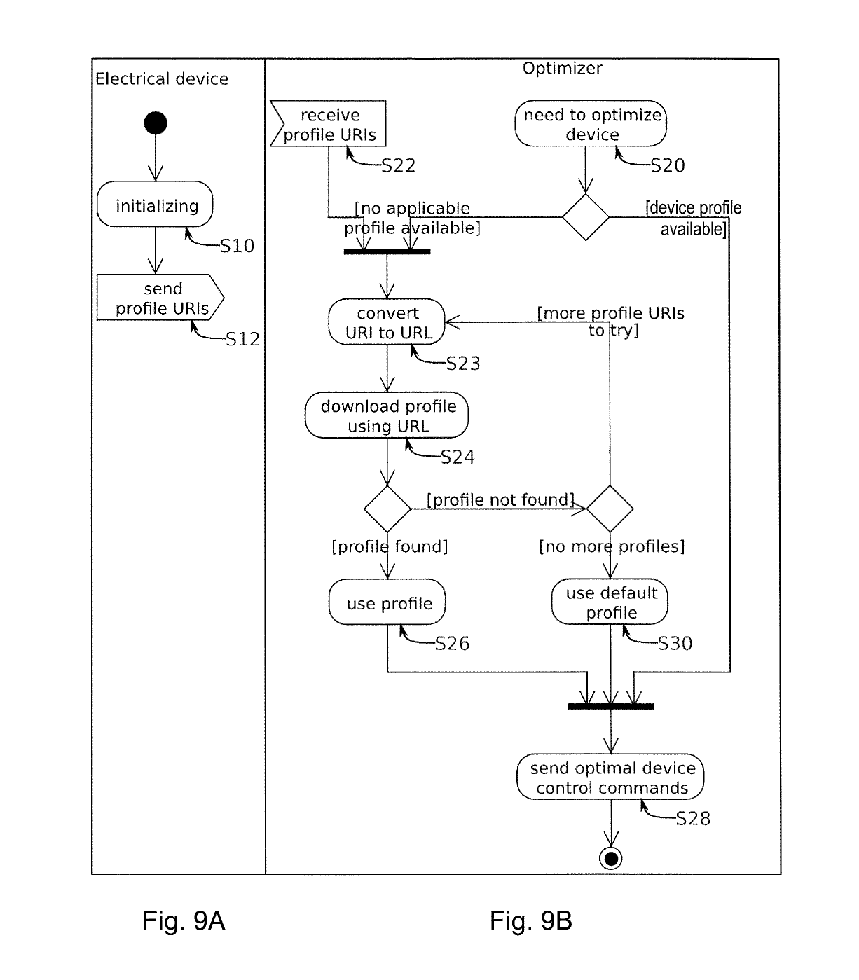

FIGS. 9A and 9B provide UML (Unified Modeling Language) sequence diagrams depicting an embodiment of a method (FIG. 9A) carried out by an electrical device and a control method (FIG. 9B) carried out by a control device.

As shown in FIG. 9A, after an initialisation step S10 a number of device-specific location identifiers (e.g. a URI) are sent to the control device in step S12. The control device (FIG. 9B) generally is ready to receive device-specific location identifiers (step S22) for a device to be controlled. In step S24 a device profile is downloaded using an URL generated from the URI in step S23. If the device profile is found, it is ready to be used (step S26) to optimize device allocations, in particular to control the electrical device so that it contributes to optimally reaching the goal that the control device is aiming to achieve while maintaining the constraints specified in the device profile. If the initial device profile is not found, other device-specific location identifiers are tried to download a device profile in step S24. If, however, there are no more device-specific location identifiers available a default device profile (or the previously used, most recent device profile) is used (step S30) to optimize device allocations in step S28 whenever there is currently a need to optimize for a specific electrical device as determined in step S20. Such a default device profile depends on the sophistication of the control device, it might e.g. be a profile obtained from averaging a number of previously used profiles.

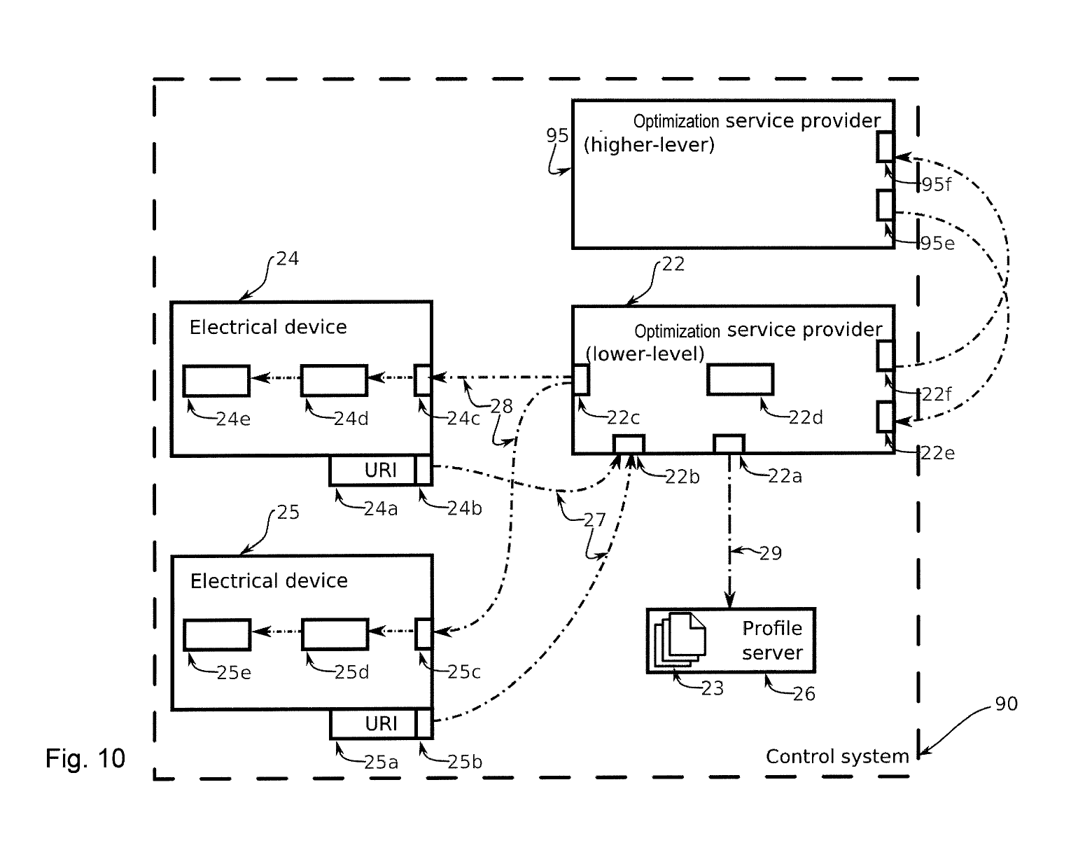

FIG. 10 shows a schematic diagram of a seventh embodiment of a control system 90 according to the present invention. In addition to the elements shown in the other embodiments, particularly the embodiment of the control system 20 shown in FIG. 2, the control device 22 further comprises a goal input 22e that sets one or more current and/or future goals for the control of said one or more electrical device. Those goals can be input by a user or controller, or can be predetermined in advance, e.g. when installing the control system. In this embodiment the control unit 22d is configured to process obtained device profiles and to generate control commands for controlling said one or more electrical devices based on the obtained device profile and the set goals.

In addition, in this embodiment the control device 22 further comprises a flexibility output 22f that communicates the available flexibility expressed in the profiles of the electrical devices controlled by said lower-level control device modulated by the restrictions imposed by said lower-level control device to one or more other, in particular higher-level, control devices 95 which, for instance, are provided on a higher level to control the (lower level) control device 22 and other control devices on the same (lower) level, e.g. control devices that are installed closer to the electrical device. For this purpose the control device 95 preferably comprises a flexibility input 95f connected with the flexibility input 95f and a goal output 95e connected with the goal input 22e.

Higher and lower level refer to a relative position in a hierarchy of control devices where a higher-level control device is using, aggregated, flexibility data from and sending goals to a lower-level control device. It has been explained before that profiles are a description of the available flexibility. The flexibility information sent by a lower-level to a higher-level control device may thus also be in, but is not restricted to, the form of a profile. Likewise, the goal sent to the lower-level control device may be in, but is not restricted to, the form of a control command. Typically, one higher-level control device controls several lower-level control devices. Furthermore, the hierarchy can be arbitrarily deep.

The present invention provides for an improved precision of device profiles and device control. Further, updating of device profiles and access to device profiles is facilitated. Still further, the present invention provides more predictable effects of the demand-response device control, an improved robustness of the electricity grid to unpredicted variations in energy production and consumption/prosumption and an improved fitness of the electricity grid for renewable energy sources.

The invention has been illustrated and described in detail in the drawings and foregoing description, but such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A control device for controlling one or more electrical devices, each having a device profile including energy usage-related information of the device, comprising:
a profile input that obtains device profiles of electrical devices to be controlled from a device-specific storage location identified by a device-specific location identifier,
an identifier input that receives device-specific location identifiers and/or device identifiers usable for generating respective device-specific location identifiers,
a control unit that processes obtained device profiles and generates control commands for controlling said one or more electrical devices based on the obtained device profiles, and
a control output that provides said control commands.

2. The control device as claimed in claim 1,
wherein said identifier input is configured to receive Universal Resource Identifiers as device-specific location identifiers, and
wherein said profile input is configured to use said Uniform Resource Identifiers to obtain the device profiles of electrical devices to be controlled from a device-specific storage location identified by the device-specific Uniform Resource Identifier.

3. The control device as claimed in claim 1,
wherein said Uniform Resource Identifier is a Uniform Resource Locator or a Uniform Resource Name.

4. The control device as claimed in claim 1,
wherein said identifier input is configured to receive device identifiers identifying one or more electrical devices to be controlled, in particular serial numbers, type identifications, electrical fingerprints, and
wherein said profile input is configured to transmit a device identifier to a device profile mapper and to receive from said device profile mapper a device-specific location identifier for the device identified by said device identifier.

5. The control device as claimed in claim 1,
further comprising a sensor input that receives sensor information from one or more sensors, said sensor information comprising data about the environment of an electrical device to be controlled,
wherein said profile input is configured to generate said device-specific location identifier from a received device identifier and said sensor information of said electrical device.

6. The control device as claimed in claim 1,
further comprising a goal input that sets one or more current and/or future goals for the control of said one or more electrical devices,
wherein control unit is configured to process obtained device profiles and to generate control commands for controlling said one or more electrical devices based on the obtained device profile and goals.

7. The control device as claimed in claim 1,
further comprising a flexibility output that communicates an available flexibility to other, in particular higher-level, control devices.

8. A control method for controlling one or more electrical devices, each having a device profile including energy usage-related information of the device, comprising:
obtaining device profiles of electrical devices to be controlled from a predetermined device-specific storage location identified by a device-specific location identifier,
receiving device-specific location identifiers and/or device identifiers that are used to generate respective device-specific location identifiers,
processing obtained device profiles and generating control commands for control-ling said one or more electrical devices based on the obtained device profiles, and
providing said control commands.

9. An electrical device having a device profile including energy usage-related information of the device, the device comprising:
an identifier output that outputs a device-specific location identifier and/or a device identifier that can be used to generate a device-specific location identifier, said device-specific location identifier identifying a device-specific storage location of the device profile of said device,
a control input that receives control commands for controlling said device based on the device-specific device profile, and
a processor for executing said control commands.

10. A control system comprising
a control device as claimed in claim 1,
one or more electrical devices controlled by said control device,
one or more storage units that store device profiles of said one or more electrical devices, said one or more storage units being identified by said device-specific location identifiers,
a first connection that connects the identifier output of said one or more electrical devices and the identifier input of said control device,
a second connection that connects the control output of said control device and the control input of said one or more electrical devices, and
a third connection that connects the profile input of said control device and said one or more storage units.

11. The control system as claimed in claim 10, further comprising a cloud that includes at least one of the control device or said one or more storage units.

12. The control system as claimed in claim 10, wherein each of said first, second and third connections are implemented as wired connection, wireless connections, telecommunications connection, electrical power line, or computer network connection.

13. A control method for controlling one or more electrical devices, each having a device profile including energy usage-related information of the device, comprising:
outputting a device-specific location identifier and/or a device identifier that can be used to generate a device-specific location identifier, said device-specific location identifier identifying a device-specific storage location of the device profile of said device,
receiving said device-specific location identifier,
obtaining a device profile of an electrical device to be controlled from a device-specific storage location identified by said device-specific location identifier,
processing an obtained device profile and generating control commands for control-ling said one or more electrical devices based on the obtained device profile, and
providing said control commands,
receiving said control commands for controlling said device, and
executing said control commands.

14. A computer program comprising program code means for causing a computer to perform the steps of said method as claimed in claim 8 when said computer program is carried out on a computer.

15. A computer readable non-transitory medium having instructions stored thereon which, when carried out on a computer, cause the computer to perform the steps of the method as claimed in claim 8.
